(19) United States
(12) Patent Application Publication
(10) Pub. No.: US 2016/0168443 A1
(43) Pub. Date: Jun. 16, 2016

(54) NANOCELLULOSE MATERIALS FOR OILFIELD APPLICATIONS

(71) Applicant: SCHLUMBERGER TECHNOLOGY CORPORATION, Sugar Land, TX (US)

(72) Inventors: Valerie Gisele Helene Lafitte, Stafford, TX (US); Mohan K.R. Panga, Katy, TX (US); Andrey Vladimirovich Yakovlev, Houston, TX (US); Geza Horvath Szabo, Sugar Land, TX (US); Julia Fernandez Del Valle, Richmond, TX (US)

(21) Appl. No.: 14/572,433

(22) Filed: Dec. 16, 2014

(51) Int. Cl. C09K 8/10; C09K 8/42; C09K 8/40; C04B 24/10; C09K 8/56; C09K 8/74; C09K 8/68; E21B 33/138; C09K 8/52

(52) U.S. Cl. CPC C09K 8/10; E21B 33/138; C09K 8/42; C09K 8/40; C09K 8/52; C09K 8/56; C09K 8/74; C09K 8/68; C04B 24/10; C09K 2208/10

(57) ABSTRACT

Treatment fluids and methods for treating a subterranean formation are disclosed that include introducing a treatment fluid into a subterranean formation, the treatment fluid containing temporarily inactive cellulose nanoparticles.

### BACKGROUND

Hydrocarbons (oil, natural gas, etc.) may be obtained from a subterranean geologic formation (a “reservoir”) by drilling a well that penetrates the hydrocarbon-bearing formation. Well treatment methods often are used to increase hydrocarbon production by using a chemical composition or fluid, such as a treatment fluid.

The use of treatment fluids containing environmentally friendly materials in oilfield industries is desirable as most chemical compositions that are not considered environmentally friendly or “green” may have potential harmful effects on both persons and/or the environment. To address this issue, “green” chemical replacements are often desired.

Cellulose fibers and their derivatives constitute one of the most abundant renewable polymer resources available on earth. Different types of cellulose fibers and/or particles can be used for viscosifying various fluids used in stimulation, drilling and cementing fluids.

However, from a wellsite delivery standpoint, addition of cellulose fibers and/or particles at the surface can increase the viscosity of the fluid prematurely, which may limit the injection rate of the fluid due to high friction pressure and/or increases the horsepower used at the surface to deliver such a fluid. The initial onset of an increase in viscosity also makes it difficult to mix the fluid and obtain a homogeneous blend of fluids, which may be desired for well treatment. Furthermore, an end application/operation of the treatment fluid may use a high percentage of cellulose fibers and/or particles in the fluid, but due to an undesirable increase in the viscosity, it may not be practical to add sufficient quantity of cellulose fibers and/or particles to the fluid.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In some embodiments, the present disclosure relates to fluids for treating a subterranean formation, the fluid including a solvent and a composition including temporarily inactive cellulose nanoparticles.

In some embodiments, the present disclosure relates to methods for treating a subterranean formation the methods including mixing temporarily inactive cellulose nanoparticles with a solvent to form a homogenous treatment fluid; and introducing the homogeneous treatment fluid into a subterranean formation.

### BRIEF DESCRIPTION OF THE DRAWINGS

The manner in which the objectives of the present disclosure and other desirable characteristics may be obtained is explained in the following description and attached drawings in which:

FIG. 1 shows a plot of the shear stress over time of various NCC containing compositions.

FIGS. 2A-C are photographs of carboxylated NCC in deionized water assessed at a pH of 2, 6, and 10 after 4 days.

### DETAILED DESCRIPTION

In the following description, numerous details are set forth to provide an understanding of the present disclosure. However, it may be understood by those skilled in the art that the methods of the present disclosure may be practiced without these details and that numerous variations or modifications from the described embodiments may be possible.

At the outset, it should be noted that in the development of any such actual embodiment, numerous implementation-specific decisions may be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary and this detailed description, each numerical value should be read once as modified by the term “about” (unless already expressly so modified), and then read again as not so modified unless otherwise indicated in context. The term about should be understood as any amount or range within 10% of the recited amount or range (for example, a range from about 1 to about 10 encompasses a range from 0.9 to 11). Also, in the summary and this detailed description, it should be understood that a range listed or described as being useful, suitable, or the like, is intended to include support for any conceivable sub-range within the range at least because every point within the range, including the end points, is to be considered as having been stated. For example, “a range of from 1 to 10” is to be read as indicating each possible number along the continuum between about 1 and about 10. Furthermore, one or more of the data points in the present examples may be combined together, or may be combined with one of the data points in the specification to create a range, and thus include each possible value or number within this range. Thus, (1) even if numerous specific data points within the range are explicitly identified, (2) even if reference is made to a few specific data points within the range, or (3) even when no data points within the range are explicitly identified, it is to be understood (i) that the inventors appreciate and understand that any conceivable data point within the range is to be considered to have been specified, and (ii) that the inventors possessed knowledge of the entire range, each conceivable sub-range within the range, and each conceivable point within the range. Furthermore, the subject matter of this application illustratively disclosed herein suitably may be practiced in the absence of any element(s) that are not specifically disclosed herein.

The methods of the present disclosure relate to introducing fluids comprising a cellulose nanoparticle, such as a temporarily inactive nanocrystalline cellulose, into a subterranean formation, where the fluid exhibits a delayed viscosity and/or yield stress increase resulting from the addition of the cellulose nanoparticle.

When nanocellulose particles are placed in treatment fluids, such as fracturing fluids, the nanocellulose particles tend to start building aggregated structures or network and quickly increase the viscosity and yield stress of the fluids and systems. Such aggregation may be driven by various factors and forces, such as, for example, hydrogen bonds, concentration effects, electrostatic forces and van der Waals forces. For example, the surfaces of neighboring untreated nanocellulose particles may be bound together by hydrogen bonds in aqueous media due to the complementary functional groups on the surface of the nanocellulose particles. Therefore, in the methods of the present disclosure, the surface of the nanocellulose particles is modified (and/or temporarily modified) in a manner that is effective to ensure a temporary initial stability of the nanocellulose particles in order to be able to temporarily disperse the nanocellulose particles for a predetermined duration in a treatment fluid before a gel network is triggered to form and/or the onset of the formation of a gel network (for example, a single-phase colloidal suspension), which increases the viscosity of the treatment fluid to a level that is desired for completing the intended downhole operation.

The treatment fluids comprising the nanocellulose particles of the present disclosure may be introduced during methods that may be applied at any time in the life cycle of a reservoir, field or oilfield; for example, the methods and treatment fluids of the present disclosure may be employed in any desired downhole application (such as, for example, stimulation, hydraulic fracturing, and cementing) at any time in the life cycle of a reservoir, field or oilfield.

The term “treatment fluid,” refers to any fluid used in a subterranean operation in conjunction with a desired function and/or for a desired purpose. The term “treatment,” or “treating,” does not imply any particular action by the fluid. For example, a treatment fluid (such as a treatment fluid comprising a cellulose nanoparticle, such as nanocrystalline cellulose (NCC) and/or a temporarily inactive NCC, where the fluid exhibits a delayed viscosity and/or yield stress increase from the time the cellulose nanoparticle is added) introduced into a subterranean formation subsequent to a leading-edge fluid may be a hydraulic fracturing fluid, an acidizing fluid (acid fracturing, acid diverting fluid), a stimulation fluid, a sand control fluid, a completion fluid, a wellbore consolidation fluid, a remediation treatment fluid, a cementing fluid, a drilling fluid, a spacer fluid, a frac-packing fluid, or gravel packing fluid. The methods of the present disclosure in which a treatment fluid comprising a cellulose nanoparticle, such as a NCC particle and/or a temporarily inactive NCC, where the fluid exhibits a delayed viscosity/yield stress increase resulting from the addition of the cellulose nanoparticle may be used in full-scale operations, pills, or any combination thereof. As used herein, a “pill” is a type of relatively small volume of specially prepared treatment fluid, such as a treatment fluid comprising a cellulose nanoparticle where the fluid exhibits a delayed viscosity/yield stress increase resulting from the addition of the cellulose nanoparticle, placed or circulated in the wellbore.

Unless otherwise indicated, the term “NCC” is used interchangeably with the term “NCC particle”.

The term “inactive cellulose nanoparticle” refers, for example, to one or more cellulose nanoparticles, such as a NCC particle, having a hindered aggregation or interaction tendency either with each other and/or with the rest of the additives in the fluid/system. In some embodiments, the inactive cellulose nanoparticles may be permanently inactive in that the inactive cellulose nanoparticles will not aggregate with each other and/or with the rest of the additives in the fluid/system during the preparation and use of the treatment fluid for the duration of the intended downhole operation. In some embodiments, “inactive cellulose nanoparticles” may be activated, such as while present in a treatment fluid, such that the cellulose nanoparticles (comprised in the inactive cellulose nanoparticles) will aggregate and/or increase the viscosity of the fluid. In some embodiments, the activation of the inactive cellulose nanoparticles may be delayed until the inactive cellulose nanoparticles are triggered to become active, such as via a chemical or physical interaction (exposure to a high temperature and/or high shear rate) and/or after a predetermined amount of time.

The term “triggerable inactive cellulose nanoparticles”, which hereinafter may also be referred to as “temporarily inactive cellulose nanoparticles”, refers, for example, to one or more cellulose nanoparticles, such as a NCC particle, having a temporarily hindered aggregation or interaction tendency either with each other and/or with the rest of the additives in the fluid/system. In embodiments, a nanocellulose particle may be made to be temporarily inactive, for example, by functionalizing the nanocellulose particles' surface, and/or by coating/encapsulating the nanocellulose particle, for example, with a soluble material and/or partially soluble material that may dissolve/degrade/disperse in the treatment fluid, after a predetermined amount time, and/or with a material that can be dissolved/degraded/dispersed upon exposure to high shear rate or at high temperature in the treatment fluid. For example, in some embodiments, one or more chemical functionalizations may be carried out to make a nanocellulose particle temporarily inactive. In some embodiments, the nanocellulose particle may be functionalized with one or more moieties that are bonded to the nanocellulose particle via a hydrolyzable bond (and optionally one or more moieties that are bonded to the nanocellulose particle via a different hydrolyzable bond having kinetics that differ from that of the other functional groups present on the surface of the nanocellulose particle. For example, hydrophilic moieties, such as polyethylene oxide, and an aliphatic moieties, such as long alkane chains, may be linked to the nanocellulose particle via an hydrolyzable bond, such as an ester bond or an amide bond, such that the hydrophobic moiety may be liberated from the particle after hydrolysis has occurred and thus the surface of the nanocellulose particle becomes more hydrophilic with the remaining moiety.

In some embodiments, the degree of hydrophobization may be directly related to the surface functionalization and manipulated by selecting the appropriate functional groups and hydrolysable bonds (the selection of which may depend on the desired application of the treatment fluid. Suitable groups that may functionalize the nanocellulose particle may include any of those mentioned in the present disclosure, or any cleavable amphiphilic functional group, or any cleavable amphiphilic polymer.

The term “surface-functionalizing” refers, for example, to the process of attaching (via a covalent or ionic bond) a functional group or chemical moiety onto a surface of a cellulose nanoparticle, such as a NCC particle. Such functionalizing may be by esterification, etherification, acetylation, silylation, oxidation, or functionalization with various other chemical moieties, such as a hydrophobic group, hydroxyls, sulfate esters, carboxylates, phosphates, halides, ethers, aldehydes, ketones, esters, amines, amides and/or various chemicals containing such groups.

The phrase “surface of the cellulose nanoparticle” refers, for example, to the outer circumferential areas of a cellulose nanoparticle, such as, for example, outer circumferential areas of a cellulose nanoparticle, such as a NCC particle, that contains moieties that are suitable to participate in chemical reactions.

The term “moiety” and/or “moieties” refer, for example, to a particular functional group or part of a molecule, such as, for example, the closely-packed hydroxyl moieties on the surface of a cellulose nanoparticle, such as a NCC particle.

The term “surface modifier” refers, for example, to a substance, such as a chemical moiety, that attaches or is attached onto a surface of a cellulose nanoparticle, such as a NCC particle. Such attachment may be by esterification, etherification, acetylation, silylation, oxidation, grafting polymers on the surface, functionalization with various chemical moieties (such as with a hydrophobic group), and noncovalent surface modification, such as adsorbing surfactants, which may interact via a hydroxyl group, sulfate ester group, carboxylate groups, phosphates, halides, ethers, aldehydes, ketones, esters, amines and/or amides.

The term “homogeneity” refers, for example, to a characteristic property of compounds and elements. The term may also be used to describe a fluid, blend of fluids, mixture or solution composed of two or more components, compounds or elements that are uniformly dispersed in each other.

The phrase “aqueous cellulose nanoparticle dispersion” or “aqueous NCC dispersion” refers, for example, to a two-phased system that is made up of cellulose nanoparticles, such as NCC particles, that are uniformly distributed throughout an aqueous matrix. Upon distribution, the cellulose nanoparticles, such as NCC particles, may form a single-phase colloidal suspension.

The term “fracturing” refers to the process and methods of breaking down a geological formation, such as the rock formation around a wellbore, and creating a fracture by pumping fluid at very high pressures (pressure above the determined closure pressure of the formation), in order to increase production rates from or injection rates into a hydrocarbon reservoir. The fracturing methods of the present disclosure may include a treatment fluid comprising a cellulose nanoparticle, such as a NCC particle and/or a temporarily inactive NCC, where the fluid exhibits a delayed viscosity and/or yield stress increase resulting from the addition of the cellulose nanoparticle in one or more of the treatment fluids, but otherwise use conventional techniques known in the art.

In embodiments, the treatment fluids of the present disclosure may be introduced into a wellbore. A “wellbore” may be any type of well, including, for example, a producing well, a non-producing well, an injection well, a fluid disposal well, an experimental well, an exploratory well, and the like. Wellbores may be vertical, horizontal, deviated some angle between vertical and horizontal, and combinations thereof, for example a vertical well with a non-vertical component.

The term “field” includes land-based (surface and sub-surface) and sub-seabed applications. The term “oilfield,” as used herein, includes hydrocarbon oil and gas reservoirs, and formations or portions of formations where hydrocarbon oil and gas are expected but may additionally contain other materials such as water, brine, or some other composition.

The term “treating temperature,” refers to the temperature of the treatment fluid that is observed while the treatment fluid is performing its desired function and/or desired purpose.

Cellulose

In embodiments, any suitable cellulose particulate material having a surface that may be modified (and/or temporarily modified) in a manner that is effective to ensure a temporary initial stability of the particulate in order to be able to temporarily disperse the nanocellulose particles for a predetermined duration in a treatment fluid before a gel network is triggered to form and/or the onset of the formation of a gel network (for example, a single-phase colloidal suspension) may be comprised in the treatment fluid of the present disclosure. Such cellulose particulate material may be used in any amount desired for the treatment operation provided that the selected amount is capable of exhibiting a delayed viscosity/yield stress increase resulting from the addition of the cellulose material.

In some embodiments, the cellulose material may be a nanocellulose material, such as cellulose nanoparticles, where the composition of the cellulose nanoparticles may vary depending on the fabrication method and the source of particles. In embodiments, any suitable cellulose nanoparticles may be comprised in the treatment fluid in an effective amount to ensure a temporary initial stability of the particulate in order to be able to temporarily disperse the nanocellulose particles for a predetermined duration in a treatment fluid before a gel network (for example, a single-phase colloidal suspension) is triggered to form and/or the onset of the formation of a gel network such that the fluid exhibits a delayed viscosity/yield stress increase resulting from the addition of the cellulose nanoparticles.

For example, the cellulose nanoparticles may be modified to be inactive (that is, the surface of the cellulose nanoparticles may be modified to have a composition such that a plurality of cellulose nanoparticles exhibits hindered aggregation or interaction tendency either with each other and/or with the rest of the additives in the treatment fluid or system) so the cellulose nanoparticles will not substantially increase the viscosity (e.g., the viscosity may not increase to more than about 1.05 times that of the base fluid to which the cellulose nanoparticles are being added, or the viscosity may not increase to more than about 1.05 times that of the viscosity of the base fluid to which the cellulose nanoparticles are being added) of the fluid (for example, the treatment fluid) at the time from when the cellulose nanoparticles are added to the fluid until a viscosity increase is desired. For example, in some embodiments, when the treatment fluid reaches the desired treatment zone (such as, for example, perforations), temperature, shear, and/or other factors may be adjusted to activate (or “trigger”, such as by exposure to a predetermined temperature or shear force) the inactive nanocellulose particles such that the particles form a gel (for example, a single-phase colloidal suspension), which increases the fluid viscosity and/or yield stress. For example, the viscosity may increase to more than about 1.05 times that of the base fluid to which the cellulose nanoparticles are being added, or the viscosity may increase to more than about 1.5 times that of the viscosity of the base fluid to which the cellulose nanoparticles are being added, or the viscosity may increase to more than about 2 times that of the viscosity of the base fluid to which the cellulose nanoparticles are being added, or the viscosity may increase to more than about 5 times that of the viscosity of the base fluid to which the cellulose nanoparticles are being added.

In some embodiments, the cellulose nanoparticles that may be used in the methods of the present disclosure include the nanocellulose materials that are described in U.S. Application Publication No. 2013/0274149, the disclosure of which is incorporated by reference herein in its entirety. For example, three suitable types of such nanocellulose materials are called nanocrystalline cellulose (NCC), microfibrillated cellulose (MFC), and bacterial cellulose (BC), which are described below. Additional details regarding these materials are described in U.S. Pat. Nos. 4,341,807, 4,374,702, 4,378,381, 4,452,721, 4,452,722, 4,464,287, 4,483,743, 4,487,634 and 4,500,546, the disclosures of each of which are incorporated by reference herein in their entirety.

Suitable nanocellulose materials may have a repetitive unit of β-1,4 linked D glucose units, as seen in the following chemical structure:

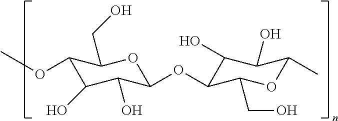

The integer values for the variable n relate to the length of the nanocellulose chains, which generally depends on the source of the cellulose and even the part of the plant containing the cellulose material.

In some embodiments, n may be an integer of from about 100 to about 10,000, such as from about 1,000 to about 10,000, or from about 1,000 to about 5,000. In other embodiments, n may be an integer of from about 5 to about 100. In other embodiments, n may be an integer of from about 5000 to about 10,000. In embodiments, the nanocellulose may include fibers or chains that may have an average diameter of from about 1 nm to about 1000 nm, such as from about 10 nm to about 500 nm, or 50 nm to about 100 nm.

Nanocrystalline cellulose (NCC), also referred to as cellulose nanocrystals, cellulose whiskers, or cellulose rod-like nanocrystals, may be obtained from cellulose fibers. Cellulose nanocrystals may have different shapes besides rods. Examples of these shapes include any nanocrystal in the shape of a 4-8 sided polygon, such as, a rectangle, hexagon or octagon. NCCs are generally made via the hydrolysis of cellulose fibers from various sources such as cotton, wood, wheat straw and cellulose from algae and bacteria. These cellulose fibers are characterized in having two distinct regions, an amorphous region and a crystalline region. In embodiments, the cellulose nanoparticles may include NCC prepared through acid hydrolysis of the amorphous regions of cellulose fibers that have a lower resistance to acid attack as compared to the crystalline regions of cellulose fibers. In some embodiments, the cellulose nanoparticles may include NCC particles with “rod-like” shapes (herein after referred to as “rod-like nanocrystalline cellulose particles” or more simply “NCC particles”) having a crystalline structure.

In some embodiments, NCC particles with “rod-like” shapes (herein after referred to as “rod-like nanocrystalline cellulose particles” or more simply “NCC particles”) having a crystalline structure may be comprised in the treatment fluid of the present disclosure that exhibits a delayed viscosity/yield stress increase resulting from the addition of the NCC particles with “rod-like” shapes.

The NCC particles may be exceptionally tough, with a strong axial Young's modulus (150 GPa) and may have a morphology and crystallinity similar to the original cellulose fibers (except without the presence of the amorphous). In some embodiments, the degree of crystallinity can vary from about 50% to about 100%, such as from about 65% to about 85%, or about 70% to about 80% by weight. In some embodiments, the degree of crystallinity is from about 85% to about 100% such as from about 88% to about 95% by weight.

In embodiments, the NCC particles may have a length of from about 50 to about 500 nm, such as from about 75 to about 300 nm, or from about 50 to about 100 nm. In embodiments, the diameter of the NCC particles may further have a diameter of from about 2 to about 500 nm, such as from about 2 to about 100 nm, or from about 2 to about 10 nm. In embodiments, the NCC particles may have an aspect ratio (length:diameter) of from about 10 to about 100, such as from about 25 to about 100, or from about 50 to about 75.

Techniques that are commonly used to determine NCC particle size are scanning electron microscopy (SEM), transmission electron microscopy (TEM) and/or atomic force microsocopy (AFM). Wide angle X-ray diffraction (WAXD) may be used to determine the degree of crystallinity.

Nanofibrillated cellulose (NFC) or Micro Fibrillated Cellulose (MFC), or nanofibrils (collectively hereinafter referred to as “MFC”), may also be used in the methods of the present disclosure. MFC is a form of nanocellulose derived from wood products, sugar beet, agricultural raw materials or waste products may also be used in the methods of the present disclosure. In MFC, the individual microfibrils have been incompletely or totally detached from each other. For example, the microfibrillated cellulose material has an average diameter of from about 5 nm to about 500 nm, from about 5 nm to about 250 nm, or from about 10 nm to about 100 nm. In some embodiments, the microfibrillated cellulose material may have an average diameter of from about 10 nm to about 60 nm. Furthermore, in MFC, the length may be up to 1 μm, such as from about 500 nm to about 1 μm, or from about 750 nm to about 1 μm. The ratio of length (L) to diameter (d) of the MFC may be from about 50 to about 150, such as from about 75 to about 150, or from about 100 to about 150.

One common way to produce MFC is the delamination of wood pulp by mechanical pressure before and/or after chemical or enzymatic treatment. Additional methods include grinding, homogenizing, intensification, hydrolysis/electrospinning and ionic liquids. Mechanical treatment of cellulosic fibers is very energy consuming and this has been a major impediment for commercial success. Additional manufacturing examples of MFC are described in WO 2007/091942, WO 2011/051882, U.S. Pat. No. 7,381,294 and U.S. Patent Application Pub. No. 2011/0036522, each of which is incorporated by reference herein in their entirety.

MFC may be similar in diameter to the NCC particle, but MFC is more flexible because NCC particles have a very high crystalline content (which limits flexibility). For example, in contrast to the high crystalline content of NCC particles, which may be homogeneously distributed or constant throughout the entire NCC particle, MFCs contain distinct amorphous regions, such as amorphous regions that alternate with crystalline regions, or amorphous regions in which crystalline regions are interspersed. Additionally, MFCs possess little order on the nanometer scale, whereas NCC particles are highly ordered. Furthermore, the crystallinity of MFCs may approach 50%, whereas the crystallinity of NCCs is higher and will depend on the method of production.

Bacterial nanocellulose may also be used in the methods of the present disclosure. Bacterial nanocellulose is a material obtained via a bacterial synthesis from low molecular weight sugar and alcohol for instance. The diameter of this nanocellulose is found to be about 20-100 nm in general. Characteristics of cellulose producing bacteria and agitated culture conditions are described in U.S. Pat. No. 4,863,565, the disclosure of which is incorporated by reference herein in its entirety. Bacterial nanocellulose particles are microfibrils secreted by various bacteria that have been separated from the bacterial bodies and growth medium. The resulting microfibrils are microns in length, have a large aspect ratio (greater than 50) with a morphology depending on the specific bacteria and culturing conditions.

While the discussion below identifies NCC particles as the particular particle being modified (and/or temporarily modified) in a manner that is effective to ensure a temporary initial stability of the particulate in order to be able to temporarily disperse the nanocellulose particles for a predetermined duration in a treatment fluid before a gel network is triggered to form and/or the onset of the formation of a gel network (for example, a single-phase colloidal suspension), other cellulose nanoparticle materials may be used to form a triggerable inactive cellulose nanoparticle product in a similar manner.

In embodiments, the modification, such as surface-only modification, that be adjusted to tailor the surface of a cellulose nanoparticle to form a triggerable or temporary inactive cellulose nanoparticle may be performed by a variety of methods, including, for example, esterification, etherification, acetylation, silylation, oxidation, grafting polymers on the surface, functionalization with various chemical moieties (such as with a hydrophobic group to improve compatibility with hydrocarbons and/or oil), and noncovalent surface modification, including the use of adsorbing surfactants and polymer coating, as desired.

In some embodiments, the NCC particle surfaces may have a percent surface functionalization of about 5 to about 90 percent, such as from of about 25 to about 75 percent, and or of about 40 to about 60 percent. In some embodiments, about 5 to about 90 percent of the hydroxyl groups on NCC particle surfaces may be chemically modified, 25 to about 75 percent of the hydroxyl groups on NCC particle surfaces may be chemically modified, or 40 to about 60 percent of the hydroxyl groups on NCC particle surfaces may be chemically modified.

Fourier Transform Infrared (FT-IR) and Raman spectroscopies and/or other known methods may be used to assess percent surface functionalization, such as via investigation of vibrational modes and functional groups present on the NCC particles. Additionally, analysis of the local chemical composition of the cellulose, NCC particles may be carried out using energy-dispersive X-ray spectroscopy (EDS). The bulk chemical composition can be determined by elemental analysis (EA). Zeta potential measurements can be used to determine the surface charge and density. Thermal gravimetric analysis (TGA) and differential scanning calorimetry (DSC) can be employed to understand changes in heat capacity and thermal stability.

The selection of specific chemicals and functional groups for surface modification and/or functionalization, and the extent of the surface modification and/or functionalization of cellulose nanoparticles will depend on a number of factors, such as, for example, the composition and pH of the treatment fluid, the downhole operation, the desired duration of the hindered aggregation or interaction tendency, the temperature at which the particles are to be used, and the mechanism of the triggering event.

In embodiments, the surface modification and/or functionalization of the NCC particles may be controlled such that triggerable inactive cellulose nanoparticles (such as triggerable inactive case NCC particles) may be formed. For example, the triggerable inactive cellulose nanoparticles having a polymer coating may be triggered to form active cellulose particles by, for example, exposure to an effective shear rate or an effective temperature, which will be dependent on the materials of the coating. Any desired coating materials and/or functional groups, such as those that are known to be temperature and/or shear sensitive, may be used to coat and/or functionalize the NCC particles. For example, a suitable wax coating that would melt at a temperature that could be generated downhole or would be encountered downhole, may be used to coat the NCC particles. Polysaccharide based polymer coating that would undergo degradation with temperature may also be used.

In embodiments, the choice of the coating and/or resultant functional groups present on the surface of the NCC particles may be used to tailor the specific properties of the NCC particles in the treatment fluid. For example, NCC particles may be functionalized such that the treatment fluids comprising the functionalized NCC particles may display a time-dependent viscosity in an aqueous treatment fluid, such as an aqueous treatment fluid having a predetermined electrolyte concentration.

In some embodiments, the NCC particles may initially have a surface that is closely packed with hydroxyl groups, which allows for chemical modifications to be performed on their surfaces such that inactive cellulose nanoparticles or triggerable inactive cellulose nanoparticles that display a time-dependent viscosity may be formed. For example, at least some of the hydroxyl groups of the NCC particles may by modified or converted to be carboxyl groups such that triggerable inactive cellulose nanoparticles that may be dispersed in an aqueous treatment fluid may be formed.

For example, the NCC particle surfaces may have a percent surface functionalization with carboxyl groups of about 5 to about 90 percent, such as from of about 25 to about 75 percent, and or of about 40 to about 60 percent. In some embodiments, about 5 to about 90 percent of the hydroxyl groups on NCC particle surfaces may be chemically modified to be carboxyl groups, 25 to about 75 percent of the hydroxyl groups on NCC particle surfaces may be chemically modified to be carboxyl groups, or 40 to about 60 percent of the hydroxyl groups on NCC particle surfaces may be chemically modified to be carboxyl groups.

In embodiments, NCC particles may be functionalized to form a functionalized NCC particle, such as a functionalized NCC particle in which the outer circumference of the nanocellulose material has been functionalized with various surface modifiers, functional groups, species and/or molecules such that the NCC particles either have slower hydration rate in a treatment fluid or use high temperature/pH change to be activated. For example, chemical functionalizations and/or modifications may be conducted to introduce stable negative or positive electrostatic charges on the surface of NCC particles. Introducing negative or positive electrostatic charges on the surface of NCC particles may result in a temporary stabilization mechanism that may be triggered to initiate aggregation/gel formation via increasing the electrolyte concentration in the treatment fluid.

In some embodiments, the methods for treating a subterranean formation of the present disclosure may include forming aggregated NCC particles after a homogeneous treatment fluid is formed by initiating the degradation of at least a portion of the coating of the NCC particle, where such a coating may comprise negative or positive electrostatic charges on or near the surface of the NCC particles. In some embodiments, the temporarily inactive cellulose nanoparticles may be non-agglomerated in the homogeneous treatment fluid prior to the initiation of the degradation of the coating (such as, for example, a polymer coating, or a temporary electric double layer) of the NCC particle.

In some embodiments, the degradation of the coating of the NCC particle may be initiated at any desired time, such as a predetermined time that is in the range of from about 1 minute to about 7 days after of the formation of the homogeneous treatment fluid, or about 2 minutes to about 12 hours after of the formation of the homogeneous treatment fluid, or about 3 minutes to about 7 hours after of the formation of the homogeneous treatment fluid, or about 15 minutes to about 7 hours after of the formation of the homogeneous treatment fluid. In some embodiments, the homogeneous treatment fluid may be any desired fluid, such as an aqueous fluid, and the NCC particle may be coated/encapsulated by a temporary electric double layer. In some embodiments, prior to the elimination of the electronic double layer the temporarily inactive cellulose nanoparticles may be non-agglomerated in the homogeneous treatment fluid.

In some embodiments, the methods for treating a subterranean formation of the present disclosure may comprise forming aggregated NCC particles after a homogeneous treatment fluid is formed by eliminating an electronic double layer coating/encapsulating the NCC particle(s). For example, the ionized surface groups introduced onto the surface of a NCC particle may provide the formation of temporary electric double layers in the interfacial region of the NCC particle/aqueous treatment fluid boundary in electrolyte solutions. In such embodiments, the triggerable inactive cellulose nanoparticles (or temporarily inactive cellulose nanoparticles) may also be referred to as “electrostatically stabilized cellulose nanoparticles.” When such double layers of the approaching NCC particles overlap a repulsive force arises, which keeps the NCC particles apart. This repulsive force is dependent, among other things, on the ionic strength of the solution, and thus the repulsion can be eliminated by increasing the ionic strength of the treatment fluid. In some embodiments, the electronic double layer may be eliminated by increasing a salt concentration of the homogeneous treatment fluid.

For example, a temporary electric double layer may be formed by functionalizing the surface of the NCC particles with —SO₄⁻ groups, which may stabilize the NCC particles at extremely low ionic strengths. In some embodiments, destabilization may occur when the ionic strength is increased, such as when the concentration of ions that may destabilize the temporary electric double layer is at a level effective to destabilize the temporary electric double layer (for example, a total concentration of calcium and magnesium ions greater than 200 mg/L may destabilize the temporary electric double layer in some embodiments).

In some embodiments, when the electrolyte concentration is increased (such as, for example, by at least about one order of magnitude, or about one to about three orders of magnitude) about the aggregation/gel formation increases the viscosity or yield stress of the treatment fluid/system. For example, in some embodiments, the viscosity may be controlled by the addition of sodium sulfate to the treatment fluid. In some embodiments, an effective amount of NCC particles may be used such that the addition of about 1 mM to about 10 mM sodium sulfate to the treatment fluid can be used to decrease the viscosity of the fluid, where increasing the sodium sulfate concentration to 100 mM or more can increase gel viscosity and yield stress. Similar effects may be achieved by manipulating the pH.

For example, in some embodiments, the viscosity may be controlled by adjusting the pH of the treatment fluid. For example, a low pH, such as a pH in a range of from about 2 to about 3, and high pH, such as a pH in a range of from about 11 to about 12, may be used to gel the treatment fluid, while a more neutral pH, such as a pH in a range of from about 5 to about 9 (or a pH in a range of from about 6 to about 8; or a pH of about 7) may be used to achieve a lower viscosity.

In some embodiments, the NCC particle surfaces may have a percent surface functionalization with ionized surface groups of about 5 to about 90 percent, such as from of about 25 to about 75 percent, and or of about 40 to about 60 percent. In some embodiments, about 5 to about 90 percent of the hydroxyl groups on NCC particle surfaces may be chemically modified with ionized surface groups, 25 to about 75 percent of the hydroxyl groups on NCC particle surfaces may be chemically modified with ionized surface groups, or 40 to about 60 percent of the hydroxyl groups on NCC particle surfaces may be chemically modified with ionized surface groups.

In embodiments, the surface of the NCC particles may be modified, such as by removing at least some of the charged surface moieties that may be present on the particles, and introducing various surface modifiers, functional groups, species and/or molecules that minimize aggregation and/or flocculation of the NCC particles when dispersed in a solvent, such as an aqueous solvent.

In embodiments, the surface of the NCC particles may be modified such that a steric stabilization property is introduced. In such embodiments, the triggerable inactive cellulose nanoparticles (or temporarily inactive cellulose nanoparticles) may also be referred to as stabilized cellulose nanoparticles.” For example, steric stabilization of the particle surface may be introduced by chemically attaching and/or coating the surface of the NCC particles with long chain polymers, such as polymers having hundreds to thousands of repeating units, where the molecular weight is high enough to effectively create stabilization. Such polymers may include long chain polymers that are soluble in an aqueous treatment fluid, including, for example, polyethylne glycol, polyvinylalcohol, polyNIPAM, and pluronic polymers.

In such embodiments, the particle-particle approach, during which the polymer chains overlap, may be penalized by entropy decrease of the system. As a result, the sterically stabilized cellulose nanoparticles could be stable even in moderately concentrated electrolyte solutions, such as a solution with an electrolyte concentration of about 50 mM or above, or a solution with an electrolyte concentration of about 50 mM to about 500 mM, as long as the polymer chain is not detached from the cellulose surface and the chain-water interaction (hydration) is strong. This steric stabilization can be utilized in a wider electrolyte concentration range (for example, an electrolyte concentration that is substantially above about 50 mM) than the electrostatic stabilization.

In some embodiments, the sterically stabilized NCC particles would neither form a 3D network nor increase the viscosity of the treatment fluid until the polymer chain is trigged to detach from the surface of the NCC particles. In some embodiments, steric stabilization of the particle surface may be introduced by grafting polymerization techniques in which any effective molecular weight polymer (that is effective to sterically stabilize the NCC particles) may reversibly grafted onto the surface of the NCC particle. In some embodiments, a polymer with a molecular weight in a range of from about 500 Daltons to about 5,000,000 Daltons, such as a polymer with a molecular weight in a range of from about 1,000 Daltons to about 1,000,000 Daltons, or a polymer with a molecular weight in a range of from about 100,000 Daltons to about 500,000 Daltons, may be grafted onto the NCC particle surface to sterically stabilize the NCC particle.

Applications

As discussed above, in embodiments, the methods of the present disclosure relate to the use of triggerable inactive cellulose nanoparticles (or temporarily inactive cellulose nanoparticles) in multiple oilfield applications. For example, triggerable inactive cellulose nanoparticles (or temporarily inactive cellulose nanoparticles) may be used as an additive in conventional well treatment fluids used in fracturing, cementing, sand control, shale stabilization, fines migration, drilling fluid, friction pressure reduction, loss circulation, well clean out, and the like. In some embodiments, the fluids, treatment fluids, or compositions of the present disclosure may comprise one or more triggerable inactive cellulose nanoparticles (or temporarily inactive cellulose nanoparticles) for the above-mentioned uses in an amount of from about 0.001 wt % to 10 wt %, such as, about 0.01 wt % to about 10 wt %, about 0.1 wt % to about 5 wt %, or of from about 0.5 wt % to about 5 wt % based on the total weight of the fluid, treatment fluid, or composition.

For example, triggerable inactive cellulose nanoparticles (or temporarily inactive cellulose nanoparticles) may also be used in well treatment fluids as, for example, a viscosifying agent, proppant transport agent, a material strengthening agent (such as for structural reinforcement for cementing), a fluid loss reducing agent, friction reducer/drag reduction agent and/or gas mitigation agent. Surface modification of the triggerable inactive cellulose nanoparticles (or temporarily inactive cellulose nanoparticles) may be employed to enhance or attenuate one or more of the properties of the cellulose nanoparticles in conjunction with the above uses, as desired.

Regarding cementing, triggerable inactive cellulose nanoparticles (or temporarily inactive cellulose nanoparticles) may be used to stabilized foamed cement slurry, as an additive for cement composite, to mitigate gas migration, to stabilize cement slurries and/or as an additive to reinforce a wellbore and/or a cement column Surface modification of the triggerable inactive cellulose nanoparticles (or temporarily inactive cellulose nanoparticles) may be employed to enhance or attenuate one or more of the properties of the cellulose nanoparticles in conjunction with the above uses, as desired.

In some embodiments, triggerable inactive cellulose nanoparticles (or temporarily inactive cellulose nanoparticles) may be incorporated into a spacer fluid, which is pumped between the mud and cement slurry to prevent contamination. Triggerable inactive cellulose nanoparticles (or temporarily inactive cellulose nanoparticles) may be added to increase and/or maintain an effective viscosity to prevent the mud mixing with the cement.

In another embodiment, triggerable inactive cellulose nanoparticles (or temporarily inactive cellulose nanoparticles) may be used to increase the thermal stability of polymer fluids, such as those fluids that contain viscoelastic surfactant (VES). Surface modification of the triggerable inactive cellulose nanoparticles (or temporarily inactive cellulose nanoparticles) (such as, for example, increasing or decreasing the charge density or the type of charge (anionic or cationic) on the surface of the cellulose nanoparticles) may be employed to enhance or attenuate one or more of the properties of the triggerable inactive cellulose nanoparticles (or temporarily inactive cellulose nanoparticles) in conjunction with the above uses, as desired.

In another embodiment, triggerable inactive cellulose nanoparticles (or temporarily inactive cellulose nanoparticles) may be used to improve the transport and the suspension of various solid materials often included in the above well treatment fluids, to transport pill materials, proppant and gravel. Surface modification of the cellulose nanoparticles may be employed to enhance or attenuate one or more of the properties of the cellulose nanoparticles in conjunction with the above uses, as desired.

In another embodiment, triggerable inactive cellulose nanoparticles (or temporarily inactive cellulose nanoparticles) may be used to increase the viscosity of aqueous fluids and non-aqueous based fluids (i.e., oil-based fluids) in a time or condition dependent manner. In some embodiments, the fluids, treatment fluids, or compositions of the present disclosure may comprise one or more triggerable inactive cellulose nanoparticles (or temporarily inactive cellulose nanoparticles) for the above-mentioned uses in an amount of from about 0.001 wt % to about 10 wt %, such as, 0.01 wt % to 10 wt %, 0.1 wt % to 5 wt %, or of from about 0.5 wt % to about 5 wt % based on the total weight of the fluid, treatment fluid, or composition.

The appropriate components and methods of patents may be selected for the present disclosure in embodiments thereof. Methods and fluids for fracturing an unconsolidated formation that includes injection of consolidating fluids, as disclosed in U.S. Pat. No. 6,732,800, the disclosure of which is herein incorporated by reference in its entirety. Techniques and fluids for the stimulation of very low permeability formations, as disclosed in U.S. Pat. No. 7,806,182, the disclosure of which is herein incorporated by reference in its entirety. Techniques and fluids for fluid-loss control in hydraulic fracturing operations and/or controlling lost circulation are known in the art, as disclosed in U.S. Pat. Nos. 7,482,311, 7,971,644, 7,956,016, and 8,381,813 the disclosures of which are herein incorporated by reference in their entireties. Fracturing fluids using degradable polymers as viscosifying agents, as disclosed in U.S. Pat. No. 7,858,561, the disclosure of which is herein incorporated by reference in its entirety. Conventional fracturing fluid breaking technologies and the design of fracturing treatments as described in U.S. Pat. No. 7,337,839, the disclosure of which is hereby incorporated by reference in its entirety. Techniques and fluids for gravel packing a wellbore penetrating a subterranean formation, as disclosed in U.S. Pat. No. 8,322,419, the disclosure of which is herein incorporated by reference in its entirety. Techniques and fluids for providing sand control within a well are known in the art, as disclosed in U.S. Pat. No. 6,752,206, the disclosure of which is herein incorporated by reference in its entirety. Techniques and compositions for drilling or cementing a wellbore are known in the art, as disclosed in U.S. Pat. No. 5,518,996, the disclosure of which is herein incorporated by reference in its entirety. Additionally, the following are some of the known methods of acidizing hydrocarbon bearing formations which can be used as part of the present method: U.S. Pat. Nos. 3,215,199; 3,297,090; 3,307,630; 2,863,832; 2,910,436; 3,251,415; 3,441,085; and 3,451,818, which are hereby incorporated by reference in their entirety.

Known methods, fluids, and compositions, such as those disclosed in the patents identified above, may be modified to incorporate an triggerable inactive cellulose nanoparticles (or temporarily inactive cellulose nanoparticles); or an triggerable inactive cellulose nanoparticles (or temporarily inactive cellulose nanoparticles) may be used as a substitute for one or more components, such as, for example, a viscosifying agent, a proppant transport agent, a material strengthening agent, a fluid loss reducing agent, a friction reducer/drag reduction agent, a gas mitigation agent an additive for a cement composite, and/or as an additive to reinforce a wellbore and/or a cement column, disclosed in the patents identified above.

In embodiments, the triggerable inactive cellulose nanoparticles (or temporarily inactive cellulose nanoparticles) added to such known fluids and/or compositions either in a pre-hydrated form in water, such as deionized water, or directly to such known fluids and/or compositions as a powder.

While the methods and treatment fluids of the present disclosure are described herein as comprising a triggerable inactive cellulose nanoparticles (or temporarily inactive cellulose nanoparticles), it should be understood that the methods and fluids of the present disclosure may optionally comprise other additional materials, such as the materials and additional components discussed in the aforementioned patents.

As discussed in more detail below, a triggerable inactive cellulose nanoparticles (or temporarily inactive cellulose nanoparticles) may perform a variety of intended functions when present in a treatment fluid, a few of which are illustrated in more detail below.

Fracturing Fluids

The fluids and/or methods of the present disclosure may be used for hydraulically fracturing a subterranean formation. Techniques for hydraulically fracturing a subterranean formation are known to persons of ordinary skill in the art, and involve pumping a fracturing fluid into the borehole and out into the surrounding formation. The fluid pressure is above the minimum in situ rock stress, thus creating or extending fractures in the formation. See Stimulation Engineering Handbook, John W. Ely, Pennwell Publishing Co., Tulsa, Okla. (1994), U.S. Pat. No. 5,551,516 (Normal et al.), “Oilfield Applications,” Encyclopedia of Polymer Science and Engineering, vol. 10, pp. 328-366 (John Wiley & Sons, Inc. New York, N.Y., 1987) and references cited therein.

In some embodiments, hydraulic fracturing involves pumping a proppant-free viscous fluid, or pad—such as water with some fluid additives to generate high viscosity—into a well faster than the fluid can escape into the formation so that the pressure rises and the rock breaks, creating artificial fractures and/or enlarging existing fractures. Then, proppant particles are added to the fluid to form slurry that is pumped into the fracture to prevent it from closing when the pumping pressure is released. In the fracturing treatment, fluids of are used in the pad treatment, the proppant stage, or both.

In some embodiments, the fluids and/or methods of the present disclosure may be employed during a first stage of hydraulic fracturing, where a fluid is injected through wellbore into a subterranean formation at high rates and pressures. In such embodiments, the fracturing fluid injection rate exceeds the filtration rate into the formation producing increasing hydraulic pressure at the formation face. When the pressure exceeds a predetermined value, the formation strata or rock cracks and fractures. The formation fracture is more permeable than the formation porosity.

In some embodiments, the fluids and/or methods of the present disclosure may be employed during a later stage of hydraulic fracturing, such as where proppant is deposited in the fracture to prevent it from closing after injection stops. In embodiments, the proppant may be coated with a curable resin activated under downhole conditions. Different materials, such as bundles of fibers, or fibrous or deformable materials, may also be used in conjunction with triggerable inactive cellulose nanoparticles (or temporarily inactive cellulose nanoparticles) to retain proppants in the fracture. Triggerable inactive cellulose nanoparticles (or temporarily inactive cellulose nanoparticles) and other materials, such as fibers, may form a three-dimensional network in the proppant, reinforcing it and limiting its flowback. At times, due to weather, humidity, contamination, or other environmental uncontrolled conditions, some of these materials can aggregate and/or agglomerate, making it difficult to control their accurate delivery to wellbores in well treatments.

Sand, gravel, glass beads, walnut shells, ceramic particles, sintered bauxites, mica and other materials may be used as a proppant. In embodiments, the triggerable inactive cellulose nanoparticles (or temporarily inactive cellulose nanoparticles) particles of the present disclosure may be used, such as in a fluid mixture, to assist in the transport proppant materials. In some embodiments, the fluids, treatment fluids, or compositions of the present disclosure may comprise one or more cellulose nanoparticles for the above-mentioned proppant-related uses in an amount of from about 0.001 wt % to about 10 wt %, such as, 0.01 wt % to 10 wt %, 0.1 wt % to 5 wt %, or of from about 0.5 wt % to about 5 wt % based on the total weight of the fluid, treatment fluid, or composition.

In some embodiments, the hydraulic fracturing fluids may be aqueous solutions containing a thickener, such as a solvatable polysaccharide, a solvatable synthetic polymer, or a viscoelastic surfactant, that when dissolved in water or brine provides sufficient viscosity to transport the proppant. Suitable thickeners may include polymers, such as guar (phytogeneous polysaccharide), and guar derivatives (hydroxypropyl guar, carboxymethylhydroxypropyl guar). Other synthetic polymers such as polyacrylamide copolymers can be used also as thickeners. Water with guar represents a linear gel with a viscosity proportional to the polymer concentration. Cross-linking agents are used which provide engagement between polymer chains to form sufficiently strong couplings that increase the gel viscosity and create visco-elasticity. Common crosslinking agents for guar and its derivatives and synthetic polymers include boron, titanium, zirconium, and aluminum. Another class of non-polymeric viscosifiers includes the use of viscoelastic surfactants that form elongated micelles. Known hydraulic fracturing fluids, may be modified to incorporate an triggerable inactive cellulose nanoparticles (or temporarily inactive cellulose nanoparticles) as a supplement to the thickener; or a triggerable inactive cellulose nanoparticles (or temporarily inactive cellulose nanoparticles) may be used as a substitute for a conventional thickener, for example, a substitute for one or more of the above mentioned thickeners.

Further, disclosed herein are methods and fluids (such as well treatment fluids) for treating a subterranean formation that triggerable inactive cellulose nanoparticles (or temporarily inactive cellulose nanoparticles) as a delayed crosslinking agent which can be used to form complexes with the crosslinking metals in aqueous polymer-viscosified systems, and methods to increase the gel cross-linking temperature. For example, the triggerable inactive cellulose nanoparticles (or temporarily inactive cellulose nanoparticles) of the present disclosure may be used as additive to the polymer fluid to potentially increase the viscosity of the formulation by forming an entangled network between the cellulose nanoparticles and the polymer in solution (by generation of an increase in initial viscosity prior to the addition of a metallic crosslinker, such as, for example, boron, titanium, zirconium, and aluminum).

In embodiments, proppant-retention agents, such as those that are commonly used during the latter stages of the hydraulic fracturing treatment to limit the flowback of proppant placed into the formation, used in the methods of the present disclosure may comprise triggerable inactive cellulose nanoparticles (or temporarily inactive cellulose nanoparticles) to assist in either the promotion or avoidance of aggregate or agglomerate formation. In some embodiments, the fluids, treatment fluids, or compositions of the present disclosure may comprise one or more triggerable inactive cellulose nanoparticles (or temporarily inactive cellulose nanoparticles) as a proppant-retention agent in an amount of from about 0.001 wt % to about 10 wt %, such as, 0.01 wt % to 10 wt %, 0.1 wt % to 5 wt %, or of from about 0.5 wt % to about 5 wt % based on the total weight of the fluid, treatment fluid, or composition. In embodiments, such triggerable inactive cellulose nanoparticles (or temporarily inactive cellulose nanoparticles) may include a surface modifier, such as a polymer that may or may not interact with the proppant or the coating on the proppant.

Triggerable inactive cellulose nanoparticles (or temporarily inactive cellulose nanoparticles), such as those described herein, can also be used in fluid mixtures to assist in the transport of proppant and/or pill materials into the fractures. In some embodiments, the fluids, treatment fluids, or compositions of the present disclosure may comprise one or more triggerable inactive cellulose nanoparticles (or temporarily inactive cellulose nanoparticles) to assist in the transport of proppant and/or pill materials in an amount of from about 0.001 wt % to about 10 wt %, such as, 0.01 wt % to 10 wt %, 0.1 wt % to 5 wt %, or of from about 0.5 wt % to about 5 wt % based on the total weight of the fluid, treatment fluid, or composition.

The success of a hydraulic fracturing treatment depends upon hydraulic fracture conductivity and fracture length. Fracture conductivity is the product of proppant permeability and fracture width; units may be expressed as millidarcy-feet. Fracture conductivity is affected by a number of known parameters. Proppant particle size distribution is a parameter that influences fracture permeability. The concentration of proppant between the fracture faces is another (expressed in pounds of proppant per square foot of fracture surface) and influences the fracture width. One may consider high-strength proppants, fluids with excellent proppant transport characteristics (ability to minimize gravity-driven settling within the fracture itself), high-proppant concentrations, or proppants having a large diameter as means to improve fracture conductivity. Weak materials, poor proppant transport, and narrow fractures may lead to poor well productivity. Relatively inexpensive materials of little strength, such as sand, are used for hydraulic fracturing of formations with small internal stresses. Materials of greater cost, such as ceramics, bauxites and others, are used in formations with higher internal stresses. Chemical interaction between produced fluids and proppants may change the proppant's characteristics. One should also consider the proppant's long-term ability to resist crushing.

Additional details regarding the disclosure of hydraulic fracturing fluids are described in U.S. Pat. No. 8,061,424, the disclosure of which is incorporated by reference herein in its entirety.

As discussed above, disclosed herein are well treatment fluids prepared that comprise triggerable inactive cellulose nanoparticles (or temporarily inactive cellulose nanoparticles) as a delayed crosslinking agent, which can be used to form complexes with the crosslinking metals in aqueous polymer-viscosified systems, and methods to increase the gel cross-linking temperature. The triggerable inactive cellulose nanoparticles (or temporarily inactive cellulose nanoparticles) of the present disclosure may be used as additive in the polymer fluid to increase the viscosity of the formulation by forming an entangled network between the nanocellulose material and the polymer in solution (i.e., generation of an increase in initial viscosity prior to the addition of the metallic crosslinker described above).

It is well known that metal-crosslinked polymer fluids can be shear-sensitive after they are crosslinked. In particular, exposure to high shear may occur within the tubulars during pumping from the surface to reservoir depth, and can cause an undesired loss of fluid viscosity and resulting problems such as screenout. As used herein, the term “high shear” refers to a shear rate of 500/second or more. The high-shear viscosity loss in metal-crosslinked polymer fluids that can occur during transit down the wellbore to the formation is generally irreversible and cannot be recovered.

High volumes of formation fracturing and other well treatment fluids are commonly thickened with polymers such as guar gum, the viscosity of which is greatly enhanced by crosslinking with a metal such as chromium aluminum, hafnium, antimony, etc., more commonly a Group 4 metal such as zirconium or titanium. In reference to Periodic Table “Groups,” the new IUPAC numbering scheme for the Periodic Table Groups is used as found in HAWLEY'S CONDENSED CHEMICAL DICTIONARY, p. 888 (11th ed. 1987). See U.S. Pat. Nos. 7,678,050 and 7,678,745, the disclosures of which are incorporated by reference herein in their entirety.

It is well known that metal-crosslinked polymer fluids can be shear-sensitive after they are crosslinked. In particular, exposure to high shear may occur within the tubulars during pumping from the surface to reservoir depth, and can cause an undesired loss of fluid viscosity and resulting problems such as screenout. As used herein, the term “high shear” refers to a shear rate of 500/second or more. The high-shear viscosity loss in metal-crosslinked polymer fluids that can occur during transit down the wellbore to the formation is generally irreversible and cannot be recovered.

High shear sensitivity of the metal crosslinked fluids can sometimes be addressed by delaying the crosslinking of the fluid so that it is retarded during the high-shear conditions and onset does not occur until the fluid has exited the tubulars. Because the treatment fluid is initially cooler than the formation and may be heated to the formation temperature after exiting the tubulars, some delaying agents work by increasing the temperature at which gelation takes place. Bicarbonate and lactate are examples of delaying agents that are known to increase the gelling temperatures of the metal crosslinked polymer fluids. Although these common delaying agents make fluids less sensitive to high shear treatments, they may at the same time result in a decrease in the ultimate fluid viscosity. Also, the common delaying agents may not adequately increase the gelation temperature for the desired delay, especially where the surface fluid mixing temperature is relatively high or the fluid is heated too rapidly during injection.

In some conventional treatment systems, borate crosslinkers have been used in conjunction with metal crosslinkers, for example, in U.S. Pat. No. 4,780,223. In theory, the borate crosslinker can gel the polymer fluid at a low temperature through a reversible crosslinking mechanism that can be broken by exposure to high shear, but can repair or heal after the high shear condition is removed. The shear-healing borate crosslinker can then be used to thicken the fluid during high shear such as injection through the wellbore while the irreversible metal crosslinking is delayed until the high shear condition is passed. A high pH, for example a pH of 9 to 12 or more, may be used to effect borate crosslinking, and in some instances as a means to control the borate crosslinking. For example, the pH and/or the borate concentration may be adjusted on the fly in response to pressure friction readings during the injection so that the borate crosslinking occurs near the exit from the tubulars in the wellbore. Suitable metal crosslinkers are stable at these high pH conditions and do not excessively interfere with the borate crosslinking.

Additional details regarding delayed crosslinking agents are described in U.S. Patent Application Pub. No. 2008/0280790, the disclosure of which is incorporated by reference herein in its entirety.

Some aspects of the present disclosure are directed to methods of treating subterranean formations using an aqueous comprising triggerable inactive cellulose nanoparticles (or temporarily inactive cellulose nanoparticles) and a mixture of a polymer that is crosslinked with a metal-ligand complex. The hydratable polymer is generally stable in the presence of dissolved salts. Accordingly, ordinary tap water, produced water, brines, and the like can be used to prepare the triggerable inactive cellulose nanoparticles (or temporarily inactive cellulose nanoparticles) and polymer solution used in an embodiment of the aqueous mixture.

In embodiments where the aqueous medium is a brine, the brine is water comprising an inorganic salt or organic salt. Some useful inorganic salts include, but are not limited to, alkali metal halides, such as potassium chloride. The carrier brine phase may also comprise an organic salt, such as sodium or potassium formate. Some inorganic divalent salts include calcium halides, such as calcium chloride or calcium bromide. Sodium bromide, potassium bromide, or cesium bromide may also be used. The salt is chosen for compatibility reasons i.e. where the reservoir drilling fluid used a particular brine phase and the completion/clean up fluid brine phase is chosen to have the same brine phase. Some salts can also function as stabilizers, for example, clay stabilizers such as KCl or tetramethyl ammonium chloride (TMAC), and/or charge screening of ionic polymers.

Steric stabilized cellulose nanoparticles (or temporarily inactive cellulose nanoparticles) may be able to withstand 10 wt. % salts, such as KCl, KBr, NaCl, NaBr, or the like, which could make these polymer fluids more advantageous for sea water or produced water applications. In some embodiments, the fluids, treatment fluids, or compositions of the present disclosure may comprise one or more steric stabilized cellulose nanoparticles in an amount of from about 0.001 wt % to about 10 wt %, such as, 0.01 wt % to 10 wt %, 0.1 wt % to 5 wt %, or of from about 0.5 wt % to about 5 wt % based on the total weight of the fluid, treatment fluid, or composition.

Fluids incorporating a triggerable inactive cellulose nanoparticles (or temporarily inactive cellulose nanoparticles) may have any suitable viscosity, such as a viscosity value of about 50 mPa-s or greater at a shear rate of about 100 s⁻¹ at treatment temperature, or about 75 mPa-s or greater at a shear rate of about 100 s⁻¹ at the treatment temperature, or about 100 mPa-s or greater at a shear rate of about 100 s⁻¹ at the treatment temperature, in some instances.

When crosslinkers are used in wellbore treatment fluids for subterranean applications, in one embodiment, one or more triggerable inactive cellulose nanoparticles (or temporarily inactive cellulose nanoparticles) and optionally a water soluble polymer may be placed into and hydrated in a mixer with water, which can contain other ingredients such as surfactants, salts, buffers, and temperature stabilizers. A concentrated crosslinker solution, comprising from 1000 ppm of the metal-ligand complex up to saturation, is added prior to the fluid mixture being pumped into the well to provide the desired concentration of the metal in the injected fluid mixture. Applications such as hydraulic fracturing, gravel packing and conformance control use such crosslinked fluid systems. The liquid crosslinker additive concentrations may range from about 0.01 volume percent to 1.0 percent by volume, such as, for example, from about 0.1 volume percent to 1.0 volume percent, based upon total volume of the liquid phase.

A buffering agent may be employed to buffer the fracturing fluid, i.e., moderate amounts of either a strong base or acid may be added without causing any large change in pH value of the fracturing fluid. In various embodiments, the buffering agent is a combination of: a weak acid and a salt of the weak acid; an acid salt with a normal salt; or two acid salts. Examples of suitable buffering agents are: NaH₂PO₄—Na₂HPO₄; sodium carbonate-sodium bicarbonate; sodium bicarbonate; and the like. By employing a buffering agent in addition to a hydroxyl ion producing material, a fracturing fluid is provided which is more stable to a wide range of pH values found in local water supplies and to the influence of acidic materials located in formations and the like. In some embodiments, the pH control agent is varied between about 0.6 percent and about 40 percent by weight of the polysaccharide employed.

Non-limiting examples of hydroxyl ion producing material include any soluble or partially soluble hydroxide or carbonate that provides the desirable pH value in the fracturing fluid to promote borate ion formation and crosslinking with the polysaccharide and polyol. The alkali metal hydroxides, for example, sodium hydroxide, and carbonates. Other acceptable materials are calcium hydroxide, magnesium hydroxide, bismuth hydroxide, lead hydroxide, nickel hydroxide, barium hydroxide, strontium hydroxide, and the like. At temperatures above about 79° C. (175° F.), potassium fluoride (KF) can be used to prevent the precipitation of MgO (magnesium oxide) when magnesium hydroxide is used as a hydroxyl ion releasing agent. The amount of the hydroxyl ion releasing agent used in an embodiment is sufficient to yield a pH value in the fracturing fluid of at least about 8.0, such as at least 8.5, or at least about 9.5, or between about 9.5 and about 12.

Aqueous fluid embodiments may also comprise an organoamino compound to adjust the pH. Examples of suitable organoamino compounds include, for example, tetraethylenepentamine (TEPA), triethylenetetramine, pentaethylenhexamine, triethanolamine (TEA), and the like, or any mixtures thereof. A particularly useful organoamino compound is TEPA. When organoamino compounds are used in fluids, they are incorporated at an amount from about 0.01 weight percent to about 2.0 weight percent based on total liquid phase weight. When used, the organoamino compound is incorporated at an amount from about 0.05 weight percent to about 1.0 weight percent based on total liquid phase weight.

A borate source can be used as a co-crosslinker, especially where low temperature, reversible crosslinking is used in the method for generally continuous viscosification before the polymer is crosslinked with the metal-ligand complex, or simultaneously. In embodiments, the aqueous mixture, such as an aqueous mixture comprising one or more triggerable inactive cellulose nanoparticles (or temporarily inactive cellulose nanoparticles), can thus include a borate source (also referred to as a borate slurry), which can either be included as a soluble borate or borate precursor such as boric acid, or it can be provided as a slurry of borate source solids for delayed borate crosslinking until the fluid is near exit from the tubular into the downhole formation. By definition, “slurry” is a mixture of suspended solids and liquids. For example, a borate slurry component can include crosslinking delay agents such as a polyol compound, including triggerable inactive cellulose nanoparticles (or temporarily inactive cellulose nanoparticles), sorbitol, mannitol, sodium gluconate and combinations thereof. The borate slurry that is used in at least some embodiments can be prepared at or near the site of the well bore or can be prepared at a remote location and shipped to the well site. Methods of preparing slurries are known in the art. In embodiments, the slurry may be prepared offsite, since this can reduce the expense associated with the transport of equipment and materials.

Solid borate crosslinking agents suitable in certain embodiments are water-reactive and insoluble in a non-aqueous slurry, but become soluble when the slurry is mixed with the aqueous medium. The term “non-aqueous”, as used herein, in one sense refers to a composition to which no water has been added as such, and in another sense refers to a composition the liquid phase of which comprises no more than about 1, 0.5, 0.1 or about 0.01 weight percent water based on the weight of the liquid phase. The liquid phase of the borate slurry in embodiments can be a hydrocarbon or oil such as naphtha, kerosene or diesel, or a non-oily liquid. In the case of hydrophobic liquids such as hydrocarbons, the solubilization of the borate solids is delayed because it takes time for the water to penetrate the hydrophobic coating on the solids.

In certain embodiments, the solids will include a slowly soluble boron-containing mineral. These may include borates, such as anhydrous borax and borate hydrate, for example, sodium tetraborate.

In one embodiment, the liquid phase of the borate slurry can include a hygroscopic liquid which is generally non-aqueous and non-oily. The liquid can have strong affinity for water to keep the water away from any crosslinking agent, which would otherwise reduce the desired delay of crosslinking, i.e., accelerate the gelation. Glycols, including glycol-ethers, and especially including glycol-partial-ethers, represent one class of hygroscopic liquids. Specific representative examples of ethylene and propylene glycols include ethylene glycol, diethylene glycol, triethylene glycol, propylene glycol, dipropylene glycol, tripropylene glycol, C₁ to C₈ monoalkyl ethers thereof, and the like. Additional examples include 1,3-propanediol, 1,4-butanediol, 1,4-butenediol, thiodiglycol, 2-methyl-1,3-propanediol, pentane-1,2-diol, pentane-1,3-diol, pentane-1,4-diol, pentane-1,5-diol, pentane-2,3-diol, pentane-2,4-diol, hexane-1,2-diol, heptane-1,2-diol, 2-methylpentane-2,4-diol, 2-ethylhexane-1,3-diol, C₁ to C₈ monoalkyl ethers thereof, and the like.

In some embodiments, the hygroscopic liquid can include glycol ethers with the molecular formula R—OCH₂CHR¹OH, where R is substituted or unsubstituted hydrocarbyl of about 1 to 8 carbon atoms and R¹ is hydrogen or alkyl of about 1 to 3 carbon atoms. Specific representative examples include solvents based on alkyl ethers of ethylene and propylene glycol, commercially available under the trade designation CELLOSOLVE, DOWANOL, and the like. Note that it is conventional in the industry to refer to and use such alkoxyethanols as solvents, but herein the slurried borate solids should not be soluble in the liquid(s) used in the borate slurry.

The liquid phase of the borate slurry can have a low viscosity that facilitates mixing and pumping, for example, less than 50 cP (50 mPa-s), less than 35 cP (35 mPa-s), or less than 10 cP (10 mPa-s) in different embodiments. The slurry liquid can in one embodiment contain a sufficient proportion of the glycol to maintain hygroscopic characteristics depending on the humidity and temperature of the ambient air to which it may be exposed, i.e. the hygroscopic liquid can contain glycol in a proportion at or exceeding the relative humectant value thereof. As used herein, the relative humectant value is the equilibrium concentration in percent by weight of the glycol in aqueous solution in contact with air at ambient temperature and humidity, for example, 97.2 weight percent propylene glycol for air at 48.9° C. (120° F.) and 10% relative humidity, or 40 weight percent propylene glycol for air at 4.4° C. (40° F.) and 90% relative humidity. In other embodiments, the hygroscopic liquid can comprise at least 50 percent by weight in the slurry liquid phase (excluding any insoluble or suspended solids) of the glycol, at least 80 percent by weight, at least 90 percent by weight, at least 95 percent by weight, or at least 98 percent by weight.

If desired, in some embodiments, the borate slurry can also include a suspension aid to help distance the suspended solids from each other, thereby inhibiting the solids from clumping and falling out of the suspension. The suspension aid can include silica, organophilic clay, polymeric suspending agents, other thixotropic agents or a combination thereof. In certain embodiments the suspension aid can include polyacrylic acid, an ether cellulosic derivative (such cellulosic derivatives are polymers (such as for example, guar) and thus when solubilized in water, these molecules may separate into individual molecules; in contrast, cellulose nanoparticles, such as NCC particles, can be made to be dispersible in water, but are not soluble in water), polyvinyl alcohol, carboxymethylmethylcellulose, polyvinyl acetate, thiourea crystals or a combination thereof. As a crosslinked acrylic acid based polymer that can be used as a suspension aid, there may be mentioned the liquid or powdered polymers available commercially under the trade designation CARBOPOL. As an ether cellulosic derivative, there may be mentioned hydroxypropyl cellulose. Suitable organophilic clays include kaolinite, halloysite, vermiculite, chlorite, attapullgite, smectite, montmorillonite, bentonite, hectorite or a combination thereof.

The crosslink delay agent can provide performance improvement in the system through increased cros slink delay, enhanced gel strength when the polymer is less than fully hydrated, and enhanced rate of shear recovery. The polyol may be present in an amount effective for improved shear recovery. In some embodiments, the polyol may be present in an amount that is not effective as a breaker or breaker aid.

In embodiments, ionic polymers (such as CMHPG) in an aqueous solution can be present in solvated coils that have a larger radius of gyration than the corresponding non-ionic parent polymer due to electric repulsions between like charges from the ionic substituents. This may cause the polymer to spread out without sufficient overlapping of the functional groups from different polymer chains for a crosslinker to react with more than one functional group (no crosslinking), or it may cause the orientation of functional groups to exist in an orientation that is difficult for the crosslinker to reach. For example, in deionized water, guar polymer can be crosslinked easily by boron crosslinker while CMHPG cannot. Screening the charges of the ionic species can reduce the electric repulsion and thus collapse the polymer coil to create some overlapping, which in turn can allow the crosslinker to crosslink the ionic polymers.

Different compounds to screen the charges of an ionic polymer (for example CMHPG), namely KCl (or other salt to increase ionic strength) to screen, or ionic surfactants to screen, such as quaternary ammonium salt for CMHPG, may be used. Salts can be selected from a group of different common salts including organic or inorganic such as KCl, NaCl, NaBr, CaCl₂, R₄N⁺Cl⁻ (for example TMAC), NaOAc etc. Surfactants can be fatty acid quaternary amine chloride (bromide, iodide), with at least one alkyl group being long chain fatty acid or alpha olefin derivatives, other substituents can be methyl, ethyl, iso-propyl type of alkyls, ethoxylated alkyl, aromatic alkyls etc. Some methods may also use cationic polymers. The triggerable inactive cellulose nanoparticles (or temporarily inactive cellulose nanoparticles) described herein may be used as an environmentally compatible ionic polymer charge screening compounds for the purpose of enhanced crosslinking ability and improved viscosity yield. For this purpose the triggerable inactive cellulose nanoparticles (or temporarily inactive cellulose nanoparticles) may be functionalized with ionic charges, as discussed above.

Some fluids according to some embodiments may also include a surfactant. In some embodiments, for example, the aqueous mixture comprises both a stabilizer such as KCl or TMAC, as well as a charge screening surfactant. This system can be particularly effective in ligand-metal crosslinker methods that also employ borate as a low temperature co-crosslinker. Additionally, any surfactant which aids the dispersion and/or stabilization of a gas component in the fluid to form an energized fluid can be used. Viscoelastic surfactants, such as those described in U.S. Pat. Nos. 6,703,352, 6,239,183, 6,506,710, 7,303,018 and 6,482,866, the disclosures of which are incorporated herein by reference in their entireties, are also suitable for use in fluids in some embodiments. Examples of suitable surfactants also include amphoteric surfactants or zwitterionic surfactants. Alkyl betaines, alkyl amido betaines, alkyl imidazolines, alkyl amine oxides and alkyl quaternary ammonium carboxylates are some examples of zwitterionic surfactants. An example of a suitable surfactant is the amphoteric alkyl amine contained in the surfactant solution AQUAT 944 (available from Baker Petrolite of Sugar Land, Tex.).

Charge screening surfactants may be employed, as previously mentioned. In some embodiments, the anionic surfactants such as alkyl carboxylates, alkyl ether carboxylates, alkyl sulfates, alkyl ether sulfates, alkyl sulfonates, α-olefin sulfonates, alkyl ether sulfates, alkyl phosphates and alkyl ether phosphates may be used. Anionic surfactants may have a negatively charged moiety and a hydrophobic or aliphatic tail, and can be used to charge screen cationic polymers. Examples of suitable ionic surfactants also include cationic surfactants, such as alkyl amines, alkyl diamines, alkyl ether amines, alkyl quaternary ammonium, dialkyl quaternary ammonium and ester quaternary ammonium compounds. Cationic surfactants may have a positively charged moiety and a hydrophobic or aliphatic tail, and can be used to charge screen anionic polymers such as CMHPG.

In other embodiments, the surfactant is a blend of two or more of the surfactants described above, or a blend of any of the surfactant or surfactants described above with one or more nonionic surfactants. Examples of suitable nonionic surfactants include, but are not limited to, alkyl alcohol ethoxylates, alkyl phenol ethoxylates, alkyl acid ethoxylates, alkyl amine ethoxylates, sorbitan alkanoates and ethoxylated sorbitan alkanoates. Any effective amount of surfactant or blend of surfactants may be used in aqueous energized fluids. The fluids may incorporate the surfactant or blend of surfactants in an amount of about 0.02 weight percent to about 5 weight percent of total liquid phase weight, or from about 0.05 weight percent to about 2 weight percent of total liquid phase weight. A further suitable surfactant is sodium tridecyl ether sulfate.

Cementing

The triggerable inactive cellulose nanoparticles (or temporarily inactive cellulose nanoparticles) may also be used as an additive in a cementing composition. Generally cementing a well includes pumping a cement slurry from the surface down the casing so that it then returns towards the surface via the annulus between the casing and the borehole. One of the purposes of cementing a well is to isolate the different formation layers traversed by the well to prevent fluid or gas migration between the different geological layers or between the layers and the surface. For safety reasons, prevention of any gas rising through the annulus between the borehole wall and the casing is desirable.

When the cement has set, it is impermeable to gas. Because of the hydraulic pressure of the height of the cement column, the injected slurry is also capable of preventing such migration. However, there is a phase, between these two states which could last several hours during which the cement slurry no longer behaves as a liquid but also does not yet behave as an impermeable solid. For this reason, additives, such as those described in U.S. Pat. Nos. 4,537,918, 6,235,809 and 8,020,618, the disclosures of which are incorporated by reference herein their entirety, may be added to maintain a gas-tight seal during the whole cement setting period.

The concept of fluid loss (discussed above in greater detail) is also observed in cement slurries. Fluid loss occurs when the cement slurry comes into contact with a highly porous or fissured formation. Fluid from the cement slurry will migrate into the formation altering the properties of the slurry. When fluid loss occurs it makes the cement hardens faster than it supposed to, which could lead to incomplete placement. Fluid loss control additives (such as, for example, substituted glycine, FLAC, crosslinked PVA, HEC, and AMPS/acrylamide copolymer) may be used to prevent or at least limit the fluid loss that may be sustained by the cement slurry during placement and its setting.

A variety of hydraulic cements can be utilized in accordance with the present application including, for example, Portland cements, slag cements, silica cements, pozzolana cements and aluminous cements. Specific examples of Portland cements include Classes A, B, C, G and H.

In embodiments, the fluids, treatment fluids, or compositions of the present disclosure may contain a foaming and/or stabilizing additive comprising triggerable inactive cellulose nanoparticles (or temporarily inactive cellulose nanoparticles), the triggerable inactive cellulose nanoparticles (or temporarily inactive cellulose nanoparticles) being present in an amount of from about 5 wt % to about 70 wt %, of from about 10 wt % to about 60 wt %, of from about 20 wt % to about 50 wt %, or of from about 30 wt % to about 40 wt % based on the total weight of the fluid, treatment fluid, or composition. In some embodiments, the fluids, treatment fluids, or compositions of the present disclosure may contain a foaming and/or stabilizing additive comprising triggerable inactive cellulose nanoparticles (or temporarily inactive cellulose nanoparticles), the triggerable inactive cellulose nanoparticles (or temporarily inactive cellulose nanoparticles) being present in an amount of from about 0.001 wt % to about 10 wt %, such as, 0.01 wt % to 10 wt %, 0.1 wt % to 5 wt %, or of from about 0.5 wt % to about 5 wt % based on the total weight of the fluid, treatment fluid, or composition.

The triggerable inactive cellulose nanoparticles (or temporarily inactive cellulose nanoparticles) may act as a binder or surface activating agent for various cement composites and potentially increase the affinity between the two different phases in the cement composites. Therefore, in addition to reinforcing set cement prepared based on conventional formulations, the presence of triggerable inactive cellulose nanoparticles (or temporarily inactive cellulose nanoparticles) may allow components with sharply-contrasting properties to co-exist in the composite formulations. For instance, hydrophobic monomers like styrene can now be mixed with slurries and cured to form new types of cement composites.

Triggerable inactive cellulose nanoparticles (or temporarily inactive cellulose nanoparticles) may be used in cementing or fracturing any wells in which stable flexible cement is desired.

According to the present disclosure, the slurry cement composition for cementing a well comprises a hydraulic cement, water, triggerable inactive cellulose nanoparticles (or temporarily inactive cellulose nanoparticles) and graphite. Graphite may be used as a coarse particulate graphite average diameter is around 70 to 500 μm for the particle size.

Portland cement containing carbon fiber and particulate graphite demonstrates reduced cement resistivity values, when compared to the resistivity values of conventional cement with no fibers or graphite present. Small concentrations of carbon fiber provide a connective path through the cement matrix for electrons to flow.

Other additives may be present in the blend, such as fillers, retarders, fluid loss prevention agents, dispersants, rheology modifiers and the like. In one embodiment, the blend also includes a polyvinyl alcohol fluid loss additive (0.1% to 1.6%) by weight of blend (“BWOB”), polysulfonate dispersant (0.5-1.5% BWOB), carbon black conductive filler aid not exceeding 1.0% BWOB, and various retarders (lignosulfonate, short-chain purified sugars with terminal carboxylate groups, and other proprietary synthetic retarder additives). In another embodiment, the blend also includes a PVA containing fluid loss additive (0.2-0.3% by weight of blend (“BWOB”), polysulfonate dispersant (0.5-1.5% BWOB), carbon black conductive filler aid not exceeding 1.0% BWOB, and various retarders (lignosulfonate, short-chain purified sugars with terminal carboxylate groups, and other proprietary synthetic retarder additives). In some formulations, silica or other weighting additives, such as hematite or barite, may be used to optimize density of the cement composite slurry during placement across the zone of interest. Any suitable silica concentrations may be used. In some embodiments, the silica concentrations may not exceed 40% BWOC (by weight of cement). This is done to prevent strength retrogression when well temperatures may exceed 230° F. For most formulations, hematite or barite does not exceed 25% BWOB or BWOC.

A further property of suitable cement slurries resides in its capacity to remain homogeneous while left to stand, for the period between the end of pumping and for setting. Very often, a more or less clear supernatant known as “free water” forms atop of the slurry column which is due to bleeding or sedimentation of the cement particles; the part of the annulus opposite the supernatant will not be adequately cemented.

A reason for this phenomenon can be found in the fact that, beyond a given threshold of dispersant concentration, the cement particles are subjected to repulsive forces. This corresponds to a saturation of the particles surface by the adsorbed molecules of dispersant, the cement particles then acting as elementary entities adapted to sediment in a liquid medium.

If on the contrary, the concentration of dispersant does not correspond to saturation, attractive forces remain between the negative-charge areas of a cement particle which have been covered by the dispersant, and the non-covered positive-charge areas of another cement particle, resulting in the formation, inside the liquid phase, of a fragile tridimensional structure, which contributes to keeping the particles in suspension. The pressure which is applied to this structure to destroy it and to set the fluid flowing is the “yield value” (YV). A yield value YV higher than 0 will therefore indicate the presence of such a tridimensional structure in the slurry.

In embodiments, the fluids, treatment fluids, or compositions of the present disclosure may contain a fiber comprising triggerable inactive cellulose nanoparticles (or temporarily inactive cellulose nanoparticles), the triggerable inactive cellulose nanoparticles (or temporarily inactive cellulose nanoparticles) being present in an amount of from about 5 wt % to about 70 wt %, of from about 10 wt % to about 60 wt %, of from about 20 wt % to about 50 wt %, or of from about 30 wt % to about 40 wt % based on the total weight of the fluid, treatment fluid, or composition. In some embodiments, the fluids, treatment fluids, or compositions of the present disclosure may contain a fiber comprising N triggerable inactive cellulose nanoparticles (or temporarily inactive cellulose nanoparticles) being present in an amount of from about 0.001 wt % to about 10 wt %, such as, 0.01 wt % to 10 wt %, 0.1 wt % to 5 wt %, or of from about 0.5 wt % to about 5 wt % based on the total weight of the fluid, treatment fluid, or composition.

Fracture Plugging

Fractures in reservoirs normally have the highest flow capacity of any portion of the reservoir formation. These fractures in the formation may be natural or hydraulically generated. In a natural fault in the rock structure, the high flow capacity results either from the same factors as for natural fractures or from the fracture being open for example due to natural asperities or because the rock is hard and the closure stress is low. In artificially created fractures, such as those created by hydraulic fracturing or acid fracturing, the high flow capacity results from the fracture being either propped with a very permeable bed of material or etched along the fracture face with acid or other material that has dissolved part of the formation.

Fractures of interest in this field may be connected to the subterranean formation and/or to the wellbore. Large volumes of fluids will travel through fractures due to their high flow capacity. This allows wells to have high fluid rates for production or injection. Normally, this is desirable.

However, in the course of creating or using an oil or gas well, it is often desirable to plug or partially plug a fracture in the rock formations, thereby reducing its flow capacity. Reasons for plugging these fractures may include a) they are producing unwanted water or gas, b) there is non-uniformity of injected fluid (such as water or CO₂) in an enhanced recovery flood, or c) expensive materials (such as hydraulic fracturing fluids during fracturing) are being injected into non-producing areas of the formation. This latter case can be particularly deleterious if it results in undesirable fracture growth because it wastes manpower, hydraulic horsepower, and materials, to produce a fracture where it is not wanted, and at worst it results in the growth of a fracture into a region from which undesirable fluids, such as water, are produced.

In embodiments, after well treatment composition is placed in the wellbore or the subterranean formation, at least one plug may be formed in at least one of a perforation, a fracture or the wellbore. The at least one plug is comprised of at least the triggerable inactive cellulose nanoparticles (or temporarily inactive cellulose nanoparticles) of the well treatment composition, and may be installed for diversion and/or the isolation of various zones in the wellbore or the subterranean formation. Also, after the placement, the fracture may close on the triggerable inactive cellulose nanoparticles (or temporarily inactive cellulose nanoparticles) after the well treatment composition is introduced into the fracture. Furthermore, the plug may be plurality of plugs, thus isolating one or more regions within the subterranean formation or wellbore.

To prevent particle separation and uneven packing during mixing and injection of the triggerable inactive cellulose nanoparticles (or temporarily inactive cellulose nanoparticles), the densities of the triggerable inactive cellulose nanoparticles (or temporarily inactive cellulose nanoparticles) should be within about 20% of one another other. Particles are mixed and pumped using equipment and procedures commonly used in the oilfield for cementing, hydraulic fracturing, drilling, and acidizing. These particles may be pre-mixed or mixed on site. They are generally mixed and pumped as a slurry in a carrier fluid such as water, oil, viscosified water, viscosified oil, and slick water (water containing a small amount of polymer that serves primarily as a friction reducer rather than primarily as a viscosifier). In embodiments, the well treatment composition may also comprise a carrier fluid that is not capable of dissolving the triggerable inactive cellulose nanoparticles (or temporarily inactive cellulose nanoparticles).

Unless the particles have a very low density, and/or the carrier fluid has a very high density, and/or the pump rate is very high, the carrier fluid will normally be viscosified in order to help suspend the particles. Any method of viscosifying the carrier fluid may be used. Water may be viscosified with a non-crosslinked or a crosslinked polymer. The polymer, especially if it is crosslinked, may remain and be concentrated in the fracture after the treatment and help impede fluid flow. In fracturing, polymers may be crosslinked to increase viscosity with a minimum of polymer. In embodiments, the more polymer may be better than less, unless cost prevents it, and crosslinking adds cost and complexity, so uncrosslinked fluids can be also desirable, bearing in mind that more viscous fluids tend to widen fractures, which may be undesirable.)

In fracturing, it is desirable for the polymer to decompose after the treatment, so the least thermally stable polymer that will survive long enough to place the proppant is often chosen. In embodiments, stable polymers, such as polyacrylamides, substituted polyacrylamides, and others may be advantageous. The choice of polymer, its concentration, and crosslinker, if any, is made by balancing these factors for effectiveness, taking cost, expediency, and simplicity into account

Placement of the triggerable inactive cellulose nanoparticles (or temporarily inactive cellulose nanoparticles) plugging material is similar to the placement of proppant in hydraulic fracturing. The plugging material may be suspended in a carrier fluid to form a “filling slurry”. If a fracture is being created and plugged at the same time, a “Property3D” (P3D) hydraulic fracture simulator may be used to design the fracture job and simulate the final fracture geometry and filling material placement. (If an existing fracture is being plugged, a simulator is not normally used.) Examples of such a P3D simulator are FRACADE (Schlumberger proprietary fracture design, prediction and treatment-monitoring software), FRACPRO sold by Pinnacle Technologies, Houston, Tex., USA, and MFRAC from Meyer and Associates, Inc., USA. Whether a fracture is being created and plugged in a single operation, or an existing fracture is being plugged, the fracture wall should be covered top-to-bottom and end-to-end (“length and height”) with filling slurry where the unwanted fluid flow is expected. Generally, the width of the created fracture is not completely filled with the well treatment composition, but it may be desirable to ensure that enough material is pumped to (i) at a minimum (should the fracture close after placement of the well treatment composition) create a full layer of the largest (“coarse”) size material used across the entire length and height of the region of the fracture where flow is to be impeded, or to (ii) fill the fracture volume totally with well treatment composition. When at least situation (i) has been achieved, the fracture will be said to be filled with at least a monolayer of coarse particles.

The normal maximum concentration utilized may be three layers (between the faces of the fracture) of the coarse material. If the fracture is wider than this, but will close, three layers of the filling material may be used, provided that after the fracture closes the entire length and height of the fracture walls are covered. If the fracture is wider than this, and the fracture will not subsequently close, then either (i) more filling material may be pumped to fill the fracture, or (ii) some other material may be used to fill the fracture, such as for example, the malleable material described above. More than three layers may be wasteful of particulate material, may allow for a greater opportunity of inadvertent undesirable voids in the particle pack, and may allow flowback of particulate material into the wellbore. Therefore, especially if the fracture volume filled-width is three times the largest particle size or greater, then a malleable bridging material may be added to reduce the flow of particles into the wellbore. This should be a material that does not increase the porosity of the pack on closure. Malleable polymeric or organic fibers are products that effectively accomplish this. Concentrations of up to about 9.6 g malleable bridging material per liter of carrier fluid may be used.

The carrier fluid may be any conventional fracturing fluid that will allow for material transport to entirely cover the fracture, will stay in the fracture, and will maintain the material in suspension while the fracture closes. Crosslinked guars or other polysaccharides may be used. Examples of suitable materials include crosslinked polyacrylamide or crosslinked polyacrylamides with additional groups such as AMPS to impart even greater chemical and thermal stability. Such materials may (1) concentrate in the fracture, (2) resist degradation, and provide additional fluid flow resistance in the pore volume not filled by particles. Additionally, wall-building materials, such as fluid loss additives, may be used to further impede flow from the formation into the fracture. Wall-building materials such as starch, mica, and carbonates are well known.

Often it is desirable to plug a portion of the fracture; this occurs in particular when the fracture is growing out of the desired region into a region in which a fracture through which fluid can flow is undesirable. This can be achieved using the well treatment composition described above if the area to be plugged is at the top or at the bottom of the fracture. There are two techniques to achieve this; each may be used with either a cased/perforated completion or an open hole completion. In the first (“specific gravity”) technique the bridging slurry is pumped before pumping of the main fracture slurry and has a specific gravity different from that of the main fracture slurry. If the filling slurry is heavier than the main fracture slurry, then the plugged portion of the fracture will be at the bottom of the fracture. If the filling slurry is lighter than the main fracture slurry, then the plugged portion of the fracture will be at the top of the fracture. The filling slurry will be inherently lighter or heavier than the proppant slurry simply because the particles are lighter or heavier than the proppant; the difference may be enhanced by also changing the specific gravity of the carrier fluid for the particles relative to the specific gravity of the carrier fluid for the proppant.

The second (“placement”) technique is to run tubing into the wellbore to a point above or below the perforations. If the aim is to plug the bottom of the fracture, then the tubing is run in to a point below the perforations, and the bridging slurry is pumped down the tubing while the primary fracture treatment slurry is being pumped down the annulus between the tubing and the casing. This forces the filling slurry into the lower portion of the fracture. If the aim is to plug the top of the fracture, then the tubing is run into the wellbore to a point above the perforations. Then, when the filling slurry is pumped down the tubing while the primary fracture treatment slurry is being pumped down the annulus between the tubing and the casing, the filling slurry is forced into the upper portion of the fracture. The tubing may be moved during this operation to aid placement of the particles across the entire undesired portion of the fracture. Coiled tubing may be used in the placement technique.

In embodiments, the fluids, treatment fluids, or compositions of the present disclosure may contain triggerable inactive cellulose nanoparticles (or temporarily inactive cellulose nanoparticles) (for forming plugs) in an amount of from about 5 wt % to about 70 wt %, of from about 10 wt % to about 60 wt %, of from about 20 wt % to about 50 wt %, or of from about 30 wt % to about 40 wt % based on the total weight of the fluid, treatment fluid, or composition. In some embodiments, the fluids, treatment fluids, or compositions of the present disclosure may contain triggerable inactive cellulose nanoparticles (or temporarily inactive cellulose nanoparticles) (for forming plugs) in an amount of from about 0.001 wt % to about 10 wt %, such as, 0.01 wt % to 10 wt %, 0.1 wt % to 5 wt %, or of from about 0.5 wt % to about 5 wt % based on the total weight of the fluid, treatment fluid, or composition.

The foregoing is further illustrated by reference to the following examples, which are presented for purposes of illustration and are not intended to limit the scope of the present disclosure.

### EXAMPLES

### Example 1

The following experiments were carried out to demonstrate how the initial viscosity of a cement slurry comprising carboxylated NCC was much lower than that of a similar slurry with non-modified NCC.

The cement slurry was mixed with H-class cement at a density of 16.0 lbm/gal. The following mixing procedures were used. The dry materials were massed and then blended thoroughly and uniformly prior to adding them to the mix fluid. The blender container with the tested mass of mix water and liquid additives was placed on the blender base and mixed at 4000 r/min. While mixing at 4000 r/min, the cement or cement/dry additive blend was added at a uniform rate in not more than 15 seconds. After 15 seconds (or when the dry materials have been added to the mix water) the cover was placed on the mixing container and mixing was continued at 12,000 r/min for 35 seconds.

Using the above procedure, three slurries were prepared: (i) without NCC, (ii) with non-modified (0.2% by weight of the cement (BWOC)), and (iii) with carboxylated NCC (400 mg COOH/kg of NCC sample) (0.2% BWOC). The ingredients for the formulations are shown in Table 1, the respective cellulose nanoparticles were 5-10 nm in diameter and 90-100 nm in length.

TABLE 1
Cement slurry formulation

| Component | Concentration | |
|---|---|---|
| Cement | 94 | lbs/sk |
| DI Water | 5.887 | gal/sk |
| Antifoam (Polypropylene Glycol) | 0.2% | BWOC |
| Fluid loss (AMPS/Acrylamide | 0.5% | BWOC |
| Copolymer) | | |
| Retarder (Compounded lignin | 0.9% | BWOC |
| derivative: blend of Lignin Amine | | |
| and Sodium D-Glycero-D-Gluco- | | |
| Heptonate) | | |
| Retarder aid/Dispersant (Lignin | 0.3% | BWOC |
| derivative: Tartaric Acid, Sodium | | |
| Gluconate, Sodium | | |
| Lignosulfonate) | | |
| Silica flour | 35% | BWOC |
| NCC or Carboxylated NCC | 0.2% | BWOC |

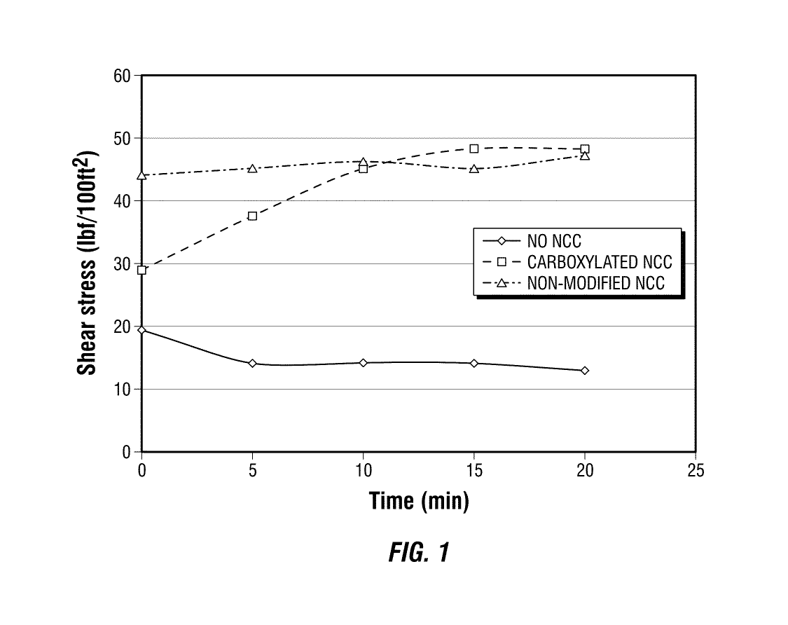

Immediately after mixing, the rheology of the slurries was measured at room temperature on a Fann 35 viscometer. Then, slurries were mixed in a blender at 3,000 rpm for 20 minutes at room temperature and the viscosity was measured every 5 minutes at shear rate 10 s⁻¹. The results are shown in FIG. 1.

As seen in FIG. 1, the initial viscosity of the cement slurry comprising carboxylated NCC was much lower than that of the slurry with non-modified NCC, which allows for easy mixing and preparation of homogeneous slurry. The viscosity of the slurry comprising carboxylated NCC increases with time and after 10-15 minutes it reaches the same viscosity level as the non-modified NCC, which helps in suspension of the cement slurry.

### Example 2

### Hydration of 1% Carboxylated NCC in Deionized Water Assessed at a pH of 2, 6, and 10 after 4 Days

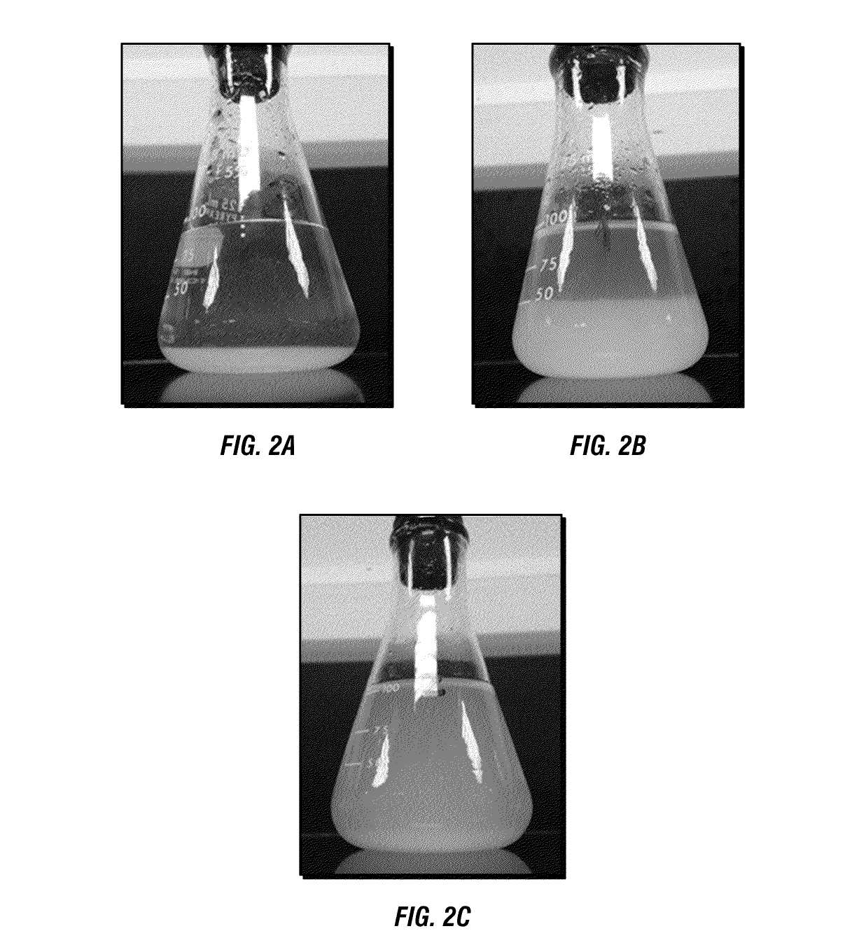

As shown in FIG. 2A-C Error! Reference source not found., hydration of 1% carboxylated NCC occurs more rapidly in an alkaline environment. This delay in hydration achieved by modifying the pH will facilitate mixing and pumping of the slurry at the surface and improves cement particle suspension downhole.

### Example 3

### Hydration of 1, 2, and 4% Carboxylated NCC in Deionized Water Assessed at a pH of 6 after 6 Days

Experiments were conducted on 1, 2, and 4% carboxylated NCC at pH 6, which was visually evaluated after 6 days. The results from the experiments reflect that at higher concentrations carboxylated NCC hydrates more rapidly. The results of these experiments suggest that hydration time is also dependent on concentration. By adjusting the concentration, it is thus possible to control the delay time to the desired levels such that viscosification may occur downhole. This will facilitate mixing and pumping at surface and enhances cement particle suspension downhole.

Although the preceding description has been described herein with reference to particular means, materials and embodiments, it is not intended to be limited to the particulars disclosed herein; rather, it extends to all functionally equivalent structures, methods and uses, such as are within the scope of the appended claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112(f) for any limitations of any of the claims herein, except for those in which the claim expressly uses the words ‘means for’ together with an associated function.

What is claimed is:

1. A fluid for treating a subterranean formation comprising:
a solvent; and
a composition comprising temporarily inactive cellulose nanoparticles.

2. The fluid for treating the subterranean formation of claim 1, wherein at least a portion of the temporarily inactive cellulose nanoparticles are sterically stabilized inactive cellulose nanoparticles.

3. The fluid for treating the subterranean formation of claim 1, wherein at least a portion of the temporarily inactive cellulose nanoparticles are electrostatically stabilized inactive cellulose nanoparticles.

4. The fluid for treating the subterranean formation of claim 1, wherein the fluid contains the temporarily inactive cellulose nanoparticles in an amount of from about 0.001 wt % to about 10 wt % of the total weight of the fluid.

5. The fluid for treating the subterranean formation of claim 1, wherein the fluid is selected from the group consisting of a fracturing fluid, well control fluid, well kill fluid, well cementing fluid, acid fracturing fluid, acid diverting fluid, a stimulation fluid, a sand control fluid, a completion fluid, a wellbore consolidation fluid, a remediation treatment fluid, a drilling fluid, a spacer fluid, a frac-packing fluid, water conformance fluid and gravel packing fluid.

6. The fluid for treating the subterranean formation of claim 1, wherein each of the temporarily inactive cellulose nanoparticles has an outer surface having a percent surface functionalization of from about 5 to about 90 percent.

7. The fluid for treating the subterranean formation of claim 6, wherein the outer surface of each of the temporarily inactive cellulose nanoparticles comprises one or more member selected from the group consisting of polymers, halides, ethers, aldehydes, ketones, esters, amines, amides, sulfate esters, phosphates, and carboxylates.

8. The fluid for treating the subterranean formation of claim 1, further comprising active cellulose nanoparticles.

9. The fluid for treating the subterranean formation of claim 1, wherein at least a portion of the temporarily inactive cellulose nanoparticles comprise a rod-like nanocrystalline cellulose particle (NCC particle) having a crystalline structure.

10. A method for treating a subterranean formation comprising:
mixing temporarily inactive cellulose nanoparticles with a solvent to form a homogenous treatment fluid; and
introducing the homogeneous treatment fluid into a subterranean formation.

11. The method for treating a subterranean formation of claim 10, wherein at least a portion of the temporarily inactive cellulose nanoparticles comprise a rod-like nanocrystalline cellulose particle (NCC particle) having a crystalline structure.

12. The method for treating a subterranean formation of claim 11, wherein the NCC particle is a coated NCC particle.

13. The method for treating a subterranean formation of claim 12, further comprising forming aggregated NCC particles after the homogeneous treatment fluid is formed by initiating the degradation of at least a portion of the coating of the NCC particle.

14. The method for treating a subterranean formation of claim 13, wherein the degradation of the coating of the NCC particle is initiated at a time that is in the range of from about 2 minutes to about 7 hours after of the formation of the homogeneous treatment fluid.

15. The method for treating a subterranean formation of claim 13, wherein the temporarily inactive cellulose nanoparticles are non-agglomerated in the homogeneous treatment fluid prior to the initiation of the degradation of the coating of the NCC particle.

16. The method for treating a subterranean formation of claim 11, wherein the homogeneous treatment fluid is an aqueous fluid, and the NCC particle is encapsulated by a temporary electric double layer.

17. The method for treating a subterranean formation of claim 12, further comprising forming aggregated NCC particles after the homogeneous treatment fluid is formed by eliminating the electronic double layer, wherein the electronic double layer is eliminated by increasing a salt concentration of the homogeneous treatment fluid.

18. The method for treating a subterranean formation of claim 17, wherein prior to the elimination of the electronic double layer the temporarily inactive cellulose nanoparticles are non-agglomerated in the homogeneous treatment fluid.

19. The method for treating a subterranean formation of claim 10, wherein the homogeneous treatment fluid is a slurry.

20. The method for treating a subterranean formation of claim 10, wherein the homogeneous treatment fluid further comprises at least one functional additive selected from the group consisting of fly ash, a silica compound, a fluid loss control additive, an emulsion, latex, a dispersant, an accelerator, a retarder, a crosslinker, a salt, mica, sand, a fiber, a formation containing agent, fumed silica, bentonite, a microsphere, a carbonate, barite, hematite, an epoxy resin and a curing agent.

21. The method for treating a subterranean formation of claim 10, wherein the homogeneous treatment fluid further comprises a hydratable polymer.

22. The method for treating a subterranean formation of claim 10, wherein the homogeneous treatment fluid is an aqueous fluid.

23. The method for treating a subterranean formation of claim 10, wherein the homogeneous treatment fluid is selected from the group consisting of a fracturing fluid, well control fluid, well kill fluid, well cementing fluid, acid fracturing fluid, acid diverting fluid, a stimulation fluid, a sand control fluid, a completion fluid, a wellbore consolidation fluid, a remediation treatment fluid, a spacer fluid, a drilling fluid, a frac-packing fluid, water conformance fluid and gravel packing fluid.

24. The method for treating a subterranean formation of claim 10, wherein a surface of temporarily inactive cellulose nanoparticles comprises one or more member selected from the group consisting of polymers, sulfate ester groups, phosphates, and carboxylate groups.

25. The method for treating a subterranean formation of claim 10, wherein the homogeneous treatment fluid is a stabilized foamed cement slurry.
